(19) United States
(12) Patent Application Publication
(10) Pub. No.: US 2009/0038774 A1
(43) Pub. Date: Feb. 12, 2009

(54) Air conditioner for vehicle

(75) Inventors: Akio Ogiso, Okazaki-city (JP); Hayato Kamigashima, Kariya-city (JP); Yasuhiro Akahori, Kariya-city (JP); Takahiro Mizuno, Kariya-city (JP)

Correspondence Address: HARNESS, DICKEY & PIERCE, P.L.C., P.O. BOX 828, BLOOMFIELD HILLS, MI, 48303, US

(73) Assignees: DENSO CORPORATION, Kariya-city (JP); Toyota Shatai Kabushiki Kaisha, Kariya-city (JP)

(21) Appl. No.: 12/221,930

(22) Filed: Aug. 7, 2008

(30) Foreign Application Priority Data
Aug. 10, 2007 (JP) 2007-209207

(51) Int. Cl. B60H 1/00

(52) U.S. Cl. 165/42; 62/239; 454/137; 454/144

(57) ABSTRACT

A vehicle air conditioner has an air conditioning unit for generating conditioned air, first and second roof outlets for blowing the air toward heads of passengers on second and third seat rows, rear face outlets for blowing the air toward an upper body of the passenger on the second seat row, a first rear foot outlet for blowing the air toward feet of the passenger on the second seat row, a second rear foot outlet for blowing the air toward calves of the passenger on the second seat row, a third rear foot outlet for blowing the air toward feet of the passenger on the third seat row, first and second pillar outlets for blowing the air toward side window glasses on sides of the second and third seat rows, and a rear side outlet for blowing the air toward upper legs of the passenger on the second seat row.

### CROSS REFERENCE TO RELATED APPLICATION

This application is based on Japanese Patent Application No. 2007-209207 filed on Aug. 10, 2007, the disclosure of which is incorporated herein by reference.

### FIELD OF THE INVENTION

The present invention relates to an air conditioner for a vehicle having at least three seat rows in a front and rear direction.

### BACKGROUND OF THE INVENTION

For example, Japanese Unexamined Patent Application Publication No. 2005-96539 describes an air conditioner which is capable of blowing conditioned air from multiple outlets toward a driver's seat and a front passenger's seat for creating a comfortable environment for passengers seated on the driver's seat and the front passenger's seat.

Recently, vehicles having three seat rows arranged behind each other along a longitudinal axis of the vehicle, such as minivan and recreational vehicle, are known. FIG. 10 shows an example of an air conditioner used for such a vehicle.

In the air conditioner shown in FIG. 10, during a cooling operation, a cool air is blown from roof outlets 73, 75 located on a ceiling 7 of a passenger compartment toward head areas of passengers seated on second and third seat rows, as shown by arrows H1, J1. Thus, the cool air is applied locally toward the head areas of the passengers seated on the second and third seat rows.

During a heating operation, warm air is blown from rear foot outlets 50, 79 located on a floor 5 of the passenger compartment toward feet of the passengers seated on the second and third seat rows, as shown by arrows F1, F2, L1, L2. Thus, the warm air is applied locally toward the foot areas of the passengers seated on the second and third seat rows.

Although not illustrated in FIG. 10, the roof outlets 73, 75 and the rear foot outlets 50, 79 are disposed symmetric with respect to a vehicle right and left direction.

### SUMMARY OF THE INVENTION

The present invention is made in view of the foregoing matter, and it is an object of the present invention to provide an air conditioner for a vehicle having at least a first seat row, a second seat row, and a third seat row arranged in a passenger compartment behind each other along a longitudinal axis of the vehicle, the air conditioner capable of enhancing comfort of passengers seated on the second and third seat rows.

According to an aspect of the present invention, an air conditioner includes an air conditioning unit, a first roof outlet, a second roof outlet, a rear face outlet, a first rear foot outlet, a second rear foot outlet, a third rear foot outlet, a first pillar outlet, a second pillar outlet, and a rear side outlet. The air conditioning unit is capable of generating a conditioned air to be introduced in the passenger compartment. The first roof outlet is disposed on a ceiling of the passenger compartment and capable of blowing the conditioned air toward a head area of a passenger seated on the second seat row. The second roof outlet is disposed on the ceiling and capable of blowing the conditioned air toward a head area of a passenger seated on the third seat row. The rear face outlet is disposed adjacent to a backrest of the first seat row and capable of blowing the conditioned air toward an upper body area of the passenger seated on the second seat row. The first rear foot outlet is disposed adjacent to a lower portion of the second seat row and capable of blowing the conditioned air toward a foot area of the passenger seated on the second seat row. The second rear foot outlet is disposed adjacent to a lower portion of the second seat row and capable of blowing the conditioned air toward a lower leg area of the passenger seated on the second seat row. The third rear foot outlet is disposed adjacent to a lower portion of the third seat row and capable of blowing the conditioned air toward a foot area of the passenger seated on the third seat row. The first pillar outlet is disposed on a pillar of the vehicle and capable of blowing the conditioned air toward a second side window glass that is located on a side of the second seat row. The second pillar outlet is disposed on the pillar of the vehicle and capable of blowing the conditioned air toward a third side window glass that is located on a side of the third seat row. The rear side outlet is disposed on a side wall of the passenger compartment and capable of blowing the conditioned air toward an upper leg area of the passenger seated on the second seat row.

Accordingly, since the rear face outlet, the second rear foot outlet, the first and second pillar outlets, and the rear side outlet are provided in addition to the first and second roof outlets and the first and third rear foot outlets, comfortable environment is created in and around the second and third seat rows. Therefore, the comfort of the passengers seated on the second and third seat rows enhances.

For example, in a cooling operation, cool air is blown from the first roof outlet, the second roof outlet and the rear face outlet. That is, the cool air is blown toward the upper body area of the passenger of the second seat row, in addition to the head areas of the passengers seated on the second and third seat rows. Therefore, an environment that the passenger seated on the second seat row is enveloped with the cool air is created. Accordingly, the comfort of the passenger sated on the second seat row in the cooling operation enhances.

For example, in a heating operation, warm air is blown from the rear face outlet, the first rear foot outlet, the second rear foot outlet, the third rear foot outlet, the first pillar outlet, the second pillar outlet, and the rear side outlet. That is, the warm air is blown toward the upper body area and the lower leg area of the passenger seated on the second seat row, in addition to the foot areas of the passengers seated on the second and third seat rows. Therefore, an environment that the passenger of the second seat row is enveloped with the warm air is created. Accordingly, the comfort of the passenger seated on the second seat row in the heating operation enhances.

Further, the warm air is blown from the first and second pillar outlets toward the inner surfaces of the side window glasses, and from the rear side outlet toward the upper leg area of the passenger seated on the second seat row. In this case, it is less likely that the passengers seated on the second and third seat rows will feel cold draft due to cold radiation from the side window glasses. As such, the comfort of the passengers seated on the second and third seat rows in the heating operation further enhances.

### BRIEF DESCRIPTION OF THE DRAWINGS

Other objects, features and advantages of the present invention will become more apparent from the following detailed description made with reference to the accompanying drawings, in which like parts are designated by like reference numbers and in which:

FIG. 1 is a perspective view of a passenger compartment of a vehicle having an air conditioner according to an embodiment of the present invention;

FIG. 2 is a schematic diagram of a front air conditioning unit of the air conditioner according to the embodiment;

FIG. 3 is a perspective view of the passenger compartment for showing outlets of the front air conditioning unit according to the embodiment;

FIG. 4 is a schematic diagram of a rear air conditioning unit of the air conditioner according to the embodiment;

FIG. 5 is a perspective view of the passenger compartment for showing outlets of the rear air conditioning unit according to the embodiment;

FIG. 6 is a chart for showing operations of air-blowing modes of the front air conditioning unit according to the embodiment;

FIG. 7 is a chart for showing operations of air-blowing modes of the rear air conditioning unit according to the embodiment;

FIG. 8 is a perspective view of a second seat row for showing an operation of a face mode according to the embodiment;

FIG. 9 is a perspective view of the second seat row for showing an operation of a bi-level mode according to the embodiment; and

FIG. 10 is a perspective view of a passenger compartment of a vehicle having an air conditioner of a related art.

### DETAILED DESCRIPTION OF EXEMPLARY EMBODIMENT

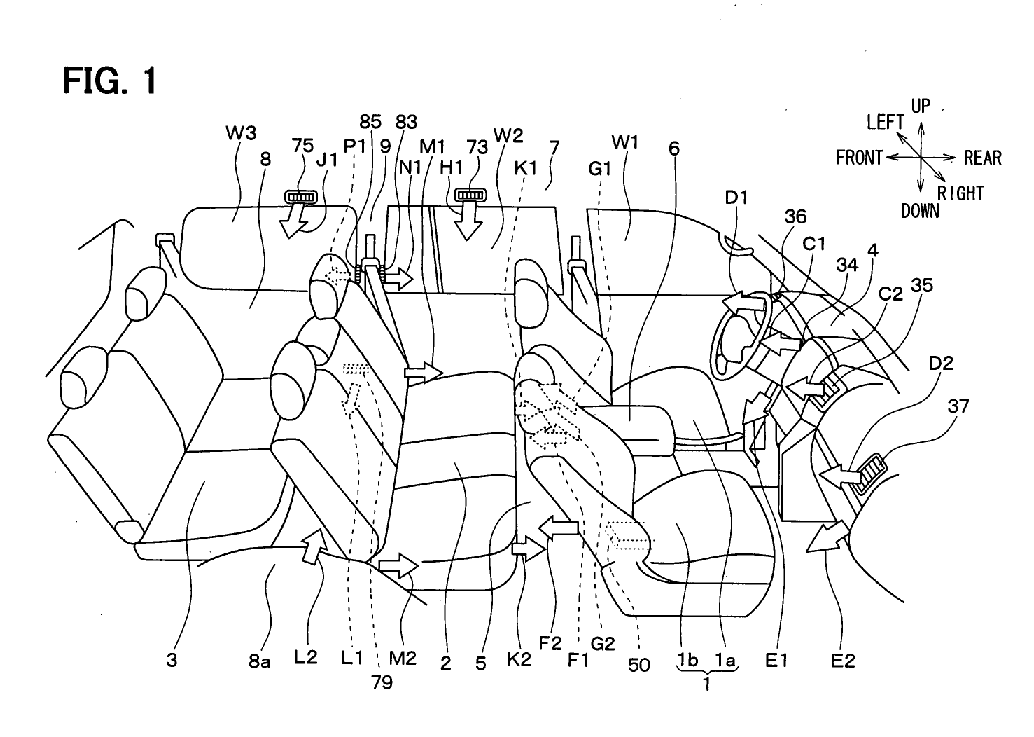

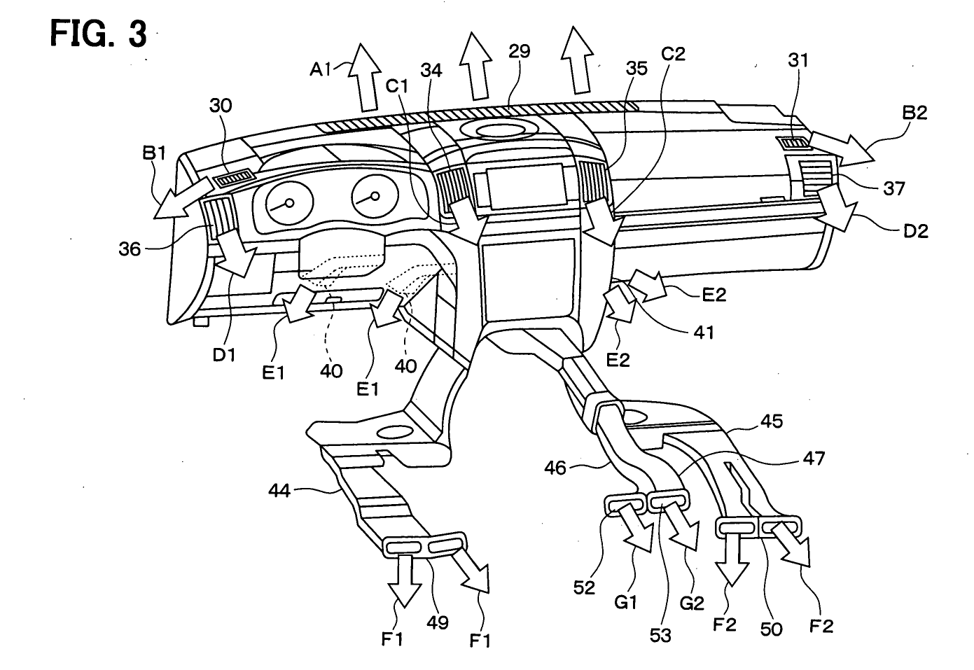

An embodiment of the present invention will be described with reference to FIGS. 1 to 9. In FIG. 1, an up and down arrow, a right and left arrow, and a front and rear arrow denote directions relative to a vehicle.

The vehicle has at least three seat rows, such as a first seat row 1, a second seat row 2, and a third seat row 3, in a passenger compartment and arranged behind each other along a longitudinal axis of the vehicle. Each of the seat rows has at least one seating position. The first seat row 1 is separated into a driver's seat 1a and a front passenger seat 1b. That is, the first seat row 1 includes the driver's seat 1a and the front passenger's seat 1b. FIG. 1 exemplarily shows a left-hand drive vehicle. The driver's seat 1a is on a left side of the front passenger seat 1b.

An air conditioner of the present embodiment includes an air conditioning unit. For example, the air conditioning unit includes a front air conditioning unit (front unit) 10 and a rear air conditioning unit (rear unit) 60.

A dashboard 4 is provided at a front-most part of the passenger compartment. The front air conditioning unit 10 is disposed inside of the dashboard 4. The front air conditioning unit 10 is provided to perform an air conditioning operation, such as a cooling operation and a heating operation, for a generally front space of the passenger compartment.

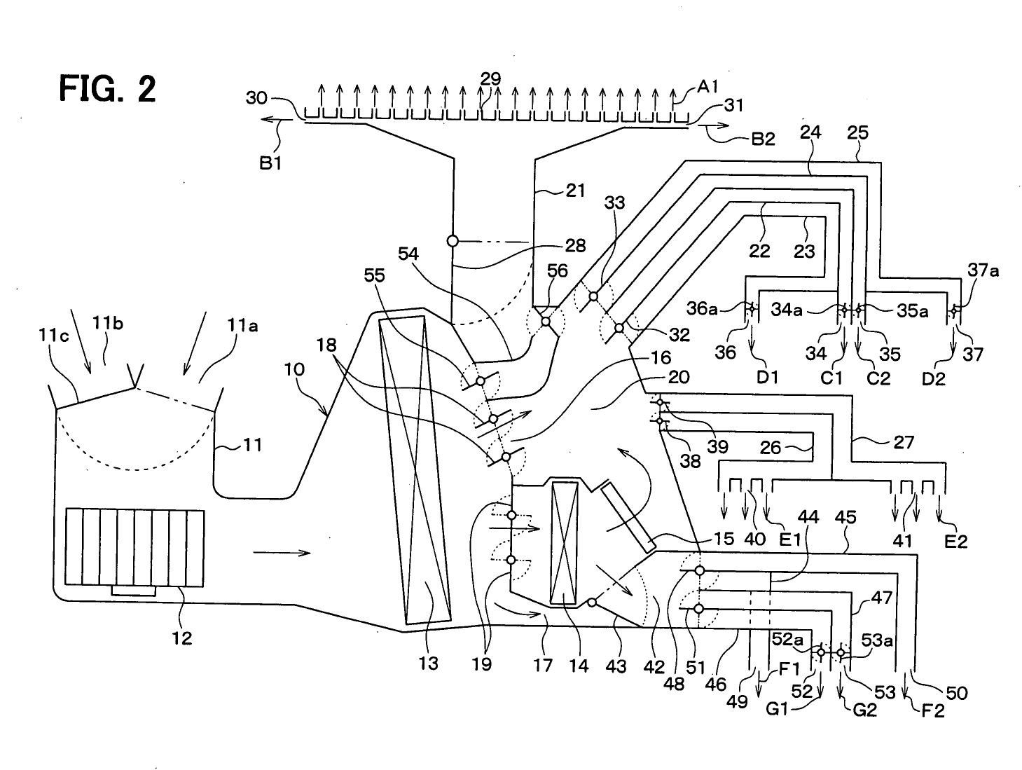

As shown in FIG. 2, the front air conditioning unit 10 generally includes an inside/outside air switching device 11, an electric blower 12, an evaporator 13 as a heat exchanger for generating cold air and a heater core 14 as a heat exchanger for generating hot air.

The inside/outside air switching device 11 has an inside air inlet port 11a, an outside air inlet port 11b and an inside/outside air switching door 11c for opening and closing the inside air inlet port 11a and the outside air inlet port 11b. Air inside of the passenger compartment (i.e., inside air) and air outside of the passenger compartment (i.e., outside air) are selectively introduced in the inside/outside air switching device 11.

The blower 12 draws the air from the inside/outside air switching device 11 and blows the air toward the evaporator 13 and the heater core 14. The evaporator 13 is included in a refrigerant cycle (not shown) that has a refrigerant compressor driven by an engine. The evaporator 13 cools the air blown from the blower 12. The heater core 14 is disposed downstream of the evaporator 13 with respect to a flow of the air. The heater core 14 heats the air passing through the evaporator 13 using heat of an engine coolant flowing inside of the heater core 14. That is, the heater core 14 heats the cold air generated by the evaporator 13.

A PTC heater 15 is disposed downstream of the heater core 14, as an auxiliary heater. The PTC heater 15 is supplied with electric power from a control unit (not shown) to generate heat when the heater core 14 cannot sufficiently heat the cold air during a heating operation. Thus, the PTC heater 15 heats the air passing through the heater core 14 in an auxiliary manner.

A first cold air bypass passage 16 and a second cold air bypass passage 17 are provided downstream of the evaporator 13 and beside the heater core 14. The first and second cold air bypass passages 16, 17 allow the cold air generated by the evaporator 13 to flow while bypassing the heater core 14.

Air mix cold doors 18 are provided in the first cold air bypass passage 16. Air mix hot doors 19 are provided between the evaporator 13 and the heater core 14. The air mix cold doors 18 and the air mix hot doors 19 are coupled to a servomotor (not shown) such that rotational positions, that is, opening degrees of the air mix cold doors 18 and the air mix hot doors 19 are continuously controlled by the servomotor.

A first air mix space 20 is provided downstream of the first cold air bypass passage 16 and the PTC heater 15. The hot air generated by the heater core 14 and/or the PTC heater 15 is mixed with the cold air passing through the first cold air bypass passage 16 in the first air mix space 20.

The volume of the hot air passing through the heater core 14 and the PTC heater 15 and the volume of the cold air passing through the first cold air bypass passage 16 are controlled by adjusting the opening degrees of the air mix hot doors 19 and the air mix cold doors 18, respectively. The hot air and the cold air are mixed with each other in the first air mix space 20, and thus a conditioned air having a predetermined temperature is generated.

The first air mix space 20 is in communication with a defroster duct 21, a left front center duct 22, a left front side duct 23, a right front center duct 24, a right front side duct 25, a left front foot duct 26, and a right front foot duct 27.

The defroster duct 21 is opened and closed by a defroster door 28. In the present embodiment, the defroster door 28 is driven by a servomotor (not shown), for example.

The defroster duct 21 is in communication with a center defroster outlet 29 and side defroster outlets 30, 31. The center defroster outlet 29 is located on an upper wall of the dashboard 4. The side defroster outlets 30, 31 is located at left and right ends of the upper wall of the dashboard 4. The conditioned air introduced in the defroster duct 21 from the first air mix space 20 is blown from the center defroster outlet 29, as shown by arrows A1, toward an inner surface of a windshield (not shown). Also, the conditioned air introduced in the defroster duct 21 from the first air mix space 20 is blown from the side defroster outlets 30, 31, as shown by arrows B1, toward inner surfaces of front side window glass W1 that are located on sides of the first seat row 1.

The left front center duct 22 and the left front side duct 23 are opened and closed by a left front center side door 32. Likewise, the right front center duct 24 and the right front side duct 25 are opened and closed by a right front center side door 33. The left front center side door 32 and the right front center side door 33 are driven by a servomotor (not shown), for example.

The left front center duct 22 and the right front center duct 24 are in communication with front center outlets 34, 35 that are located at a middle portion of a front wall of the dashboard 4. The conditioned air introduced in the left front center duct 22 and the right front center duct 24 are blown from the front center outlets 34, 35 toward upper bodies of passengers seated on the driver's seat 1a and the front passenger's seat 1b, as shown by arrows C1, C2. The front enter outlets 34, 35 are capable of being opened and closed by outlet doors 34a, 35a, respectively. The outlet doors 34a, 35a are driven by a servomotor (not shown), for example.

The left front side duct 23 and the right front side duct 25 are in communication with front side outlets 36, 37 that are located at left and right ends of the front wall of the dashboard 4. The conditioned air introduced in the left front side duct 23 and the right front side duct 25 are blown from the front side outlets 36, 37 toward the upper bodies of the passengers seated on the driver's seat 1a and the front passenger's seat 1b, as shown by arrows D1, D2. The front side outlets 36, 37 are capable of being opened and closed by outlet doors 36a, 37a. The outlet doors 36a, 37a are driven by a servomotor (not shown), for example.

The left front foot duct 26 is opened and closed by a left front foot door 38. The right front foot duct 27 is opened and closed by a right front foot door 39. The left front foot door 38 and the right front foot door 39 are driven by a servomotor (not shown), for example.

The left front foot duct 26 and the right front foot duct 27 are in communication with front foot outlets 40, 41 that are located adjacent to lower portions of the first seat row 1, such as adjacent to foot areas of the passengers seated on the driver's seat 1a and the front passenger's seat 1b. The conditioned air introduced in the left front foot duct 26 and the right front foot duct 27 are blown from the front foot outlets 40, 41 toward the foot areas of the passengers seated on the driver's seat 1a and the front passenger's seat 1b, as shown by arrows E1, E2.

A second air mix space 42 is provided downstream of the second cold air bypass passage 17 and the heater core 14. The cool air passing through the second cold air bypass passage 17 and the hot air passing through the heater core 14 are mixed with each other in the second air mix space 42.

A ratio of the volume of the cold air to the volume of the hot air introduced in the second air mix space 42 is controlled by an air mix door 43. The air mix door 43 is driven by a servomotor (not shown) such that a rotational position, that is, an opening degree of the air mix door 43 is continuously controlled.

As such, the ratio of the volume of the hot air flowing into the second air mix space 42 after passing through the heater core 14 to the volume of the cold air flowing into the second air mix space 42 from the second cold air bypass passage 17 is controlled by adjusting the opening degree of the air mix door 43. Accordingly, the hot air and the cold air are mixed with each other in the second air mix space 42, and thus a conditioned air having a predetermined temperature is generated.

The second air mix space 42 is in communication with a left rear foot duct 44, a right rear foot duct 45, a left rear face duct 46, and a right rear face duct 47.

The left rear foot duct 44 and the right rear foot duct 45 are opened and closed by a rear foot door 48. The rear foot door 48 is driven by a servomotor (not shown), for example.

The left rear foot duct 44 and the right rear foot duct 45 are in communication with first rear foot outlets 49, 50 that are located adjacent to front lower portions of the second seat row 2, such as adjacent to foot areas of passengers seated on the second seat row 2. The conditioned air introduced in the left rear foot duct 44 and the right rear foot duct 45 are blown from the first rear foot outlets 49, 50 toward the foot areas of the passengers seated on the second seat row 2, as shown by arrows F1, F2. For example, the first rear foot outlets 49, 50 are located on the floor 5 and under the driver's seat 1a and the front passenger's seat 1b.

The left rear face duct 46 and the right rear face duct 47 are opened and closed by a rear face door 51. The rear face door 51 is driven by a servomotor (not shown), for example.

The left rear face duct 46 and the right rear face duct 47 are in communication with rear face outlets 52, 53 that are located adjacent to backrests of the first seat row 1. The conditioned air introduced in the left rear face duct 46 and the right rear face duct 47 are blown from the rear face outlets 52, 53 toward upper bodies of the passengers seated on the second seat row 2, as shown by arrows G1, G2.

For example, the rear face outlets 52, 53 are located on a rear face of a console 6 that is provided between the driver's seat 1a and the front passenger's seat 1b. The rear face outlets 52, 53 are opened and closed by outlet doors 52a, 53a, respectively. The outlet doors 52a, 53a are driven by a servomotor (not shown), for example.

A cold air bypass duct 54 is provided downstream of the evaporator 13 for introducing the cold air passing through the evaporator 13 toward the defroster duct 21, the left front center duct 22, the left front side duct 23, the right front center duct 24, and the right front side duct 25, while bypassing the first air mix space 20.

The cold air bypass duct 54 is opened and closed by cold air bypass doors 55, 56. The cold air bypass doors 55, 56 are driven by a servomotor (not shown), for example.

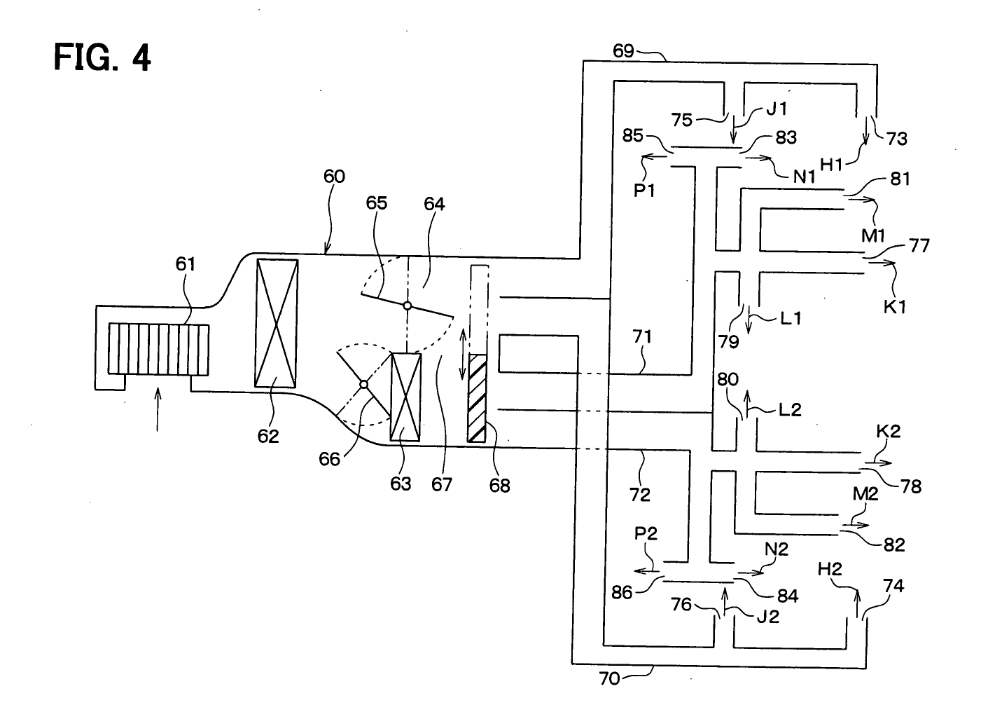

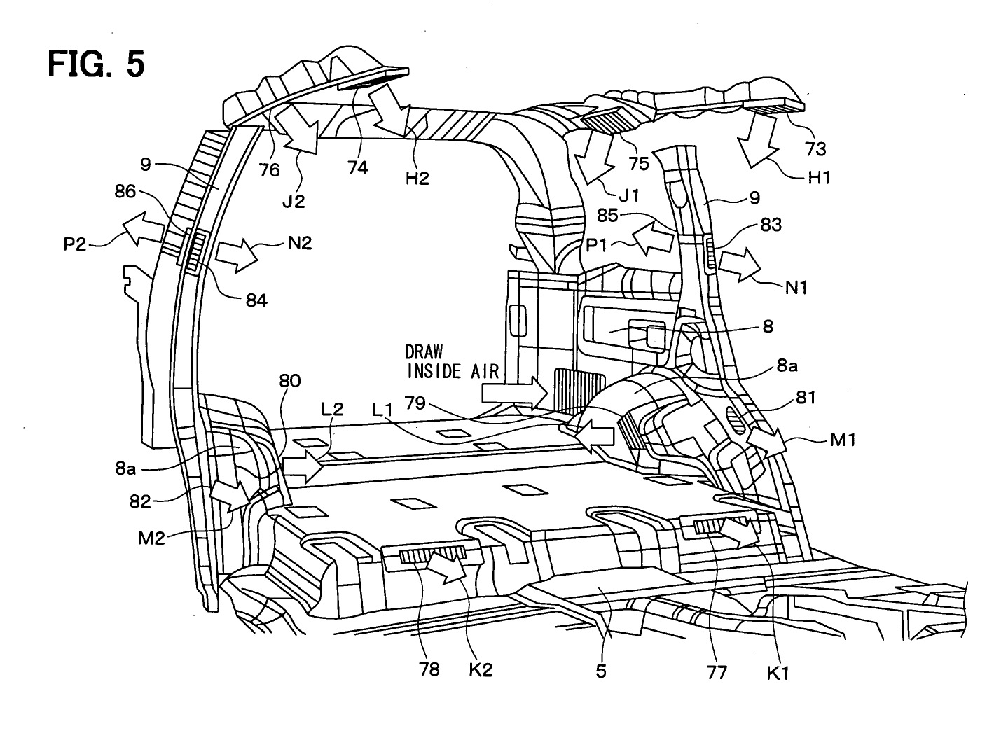

Referring to FIGS. 4 and 5, the rear air conditioning unit 60 is arranged at a rear portion of the passenger compartment for performing an air conditioning operation, such as a cooling operation and a heating operation, for a generally rear space of the passenger compartment. The rear air conditioning unit 60 is, for example, mounted in a space provided between a vehicle outer panel and an interior rear trim, such as an inner wall defining the passenger compartment.

The rear air conditioning unit 60 generally includes an electric blower 61, an evaporator 62 as a heat exchanger for generating cold air, and a heater core 63 as a heat exchanger for generating hot air.

The blower 61 draws the inside air and blows the inside air toward the evaporator 62 and the heater core 63. The evaporator 62 is included in the refrigerant cycle, similar to the evaporator 13 of the front air conditioning unit 10, for cooling the air blown by the blower 61. The heater core 23 heats the cold air generated by the evaporator 62 using heat of the engine coolant flowing inside of the heater core 23, similar to the heater core 14 of the front air conditioning unit 10.

A cold air bypass passage 64 is provided downstream of the evaporator 62 and beside the heater core 63. The cold air bypass passage 64 allows the cold air generated by the evaporator 62 to flow while bypassing the heater core 63.

An air mix cold door 65 is provided in the cold air bypass passage 64. An air mix hot door 66 is provided between the evaporator 62 and the heater core 63. The air mix cold door 65 and the air mix hot door 66 are driven by a servomotor (not shown) such that rotational positions, that is, opening degrees of the air mix cold door 65 and the air mix hot door 66 are continuously controlled.

As such, the volume of the hot air passing through the heater core 63 and the volume of the cold air passing through the cold air bypass passage 64 are adjusted by controlling the opening degrees of the air mix hot door 66 and the air mix cold door 65. The hot air and the cold air are mixed with each other in an air mix space 67 that is provided downstream of the cold air bypass passage 64 and the heater core 63. Accordingly, a conditioned air having a predetermined temperature is generated.

The air mix space 67 is in communication with a left rear roof duct 69, a right rear roof duct 70, a left rear foot duct 71 and a right rear foot duct 72. The left rear roof duct 69 is opened and closed by a slide door 68. The slide door 68 is driven by a servomotor (not shown), for example.

The left rear roof duct 69 and the right rear roof duct 70 are in communication with first roof outlets 73, 74 and second roof outlets 75, 76. The first roof outlets 73, 74 are located at left and right ends of the ceiling 7 at middle portions with respect to the vehicle front and rear direction. The second roof outlets 75, 76 are formed on the left and right ends of the ceiling 7 at rear portions with respect to the vehicle front and rear direction. The conditioned air introduced in the left rear roof duct 69 and the right rear roof duct 70 from the air mix space 67 is blown from the first roof outlets 73, 74 toward heads of the passengers seated on the second seat row 2, as shown by arrows H1, H2. Also, the conditioned air introduced in the left rear roof duct 69 and the right rear roof duct 70 is blown from the second roof outlets 75, 76 toward heads of the passengers seated on the third seat row 3, as shown by arrows J1, J2.

The conditioned air introduced in the left rear foot duct 71 and the right rear foot duct 72 are blown from second rear foot outlets 77, 78, third rear foot outlets 79, 80, rear side outlets 81, 82, first pillar outlets 83, 84 and second pillar outlets 85, 86.

The second rear foot outlets 77, 78 are located adjacent leg areas such as calves of the passengers seated on the second seat row 2. Thus, the conditioned air is blown from the second rear foot outlets 77, 78 toward the calves of the passengers seated on the second seat row 2, as shown by arrows K1, K2. For example, the second rear foot outlets 77, 78 are located on the floor 5 under the second seat row 2.

The third rear foot outlets 79, 80 are located adjacent to foot areas of the passengers seated on the third seat row 3. The conditioned air is blown from the third rear foot outlets 79, 80 toward the foot areas of the passengers seated on the third seat row 3, as shown by arrows L1, L2. For example, the third rear foot outlets 79, 80 are located on rear wheel housings 8a and adjacent to the floor 5.

The rear side outlets 81, 82 are located on side walls 8 of the vehicle adjacent to hips of the passengers seated on the second seat row 2. The conditioned air is blown from the rear side outlets 81, 82 toward the hips and upper legs of the passengers seated on the second seat row 2, as shown by arrows M1, M2.

The first pillar outlets 83, 84 are located on front portions of pillars of the vehicle, such as C pillars 9. The conditioned air is blown from the first pillar outlets 83, 84 toward inner surfaces of second side window glasses W2 located on the sides of the second seat row 2 (hereinafter, second seat row window glasses), as shown by arrows N1, N2.

The second pillar outlets 85, 86 are located on rear portions of the pillars, such as the C pillars 9. The conditioned air is blown from the second pillar outlets 85, 86 toward inner surfaces of third side window glasses W3 located on the sides of the third seat row 3 (hereinafter, third seat row window glasses), as shown by arrows P1, P2.

The air conditioner is provided with an air conditioner electronic control unit (ECU), although not illustrated. The electronic control unit is constructed of a microcomputer including a CPU, a ROM, a RAM, an I/O and the like. The electronic control unit executes various processing such as computations in accordance with programs, which are stored in the ROM and the like, and controls the servomotors for driving the various doors 18, 19, 32, 33 and the like.

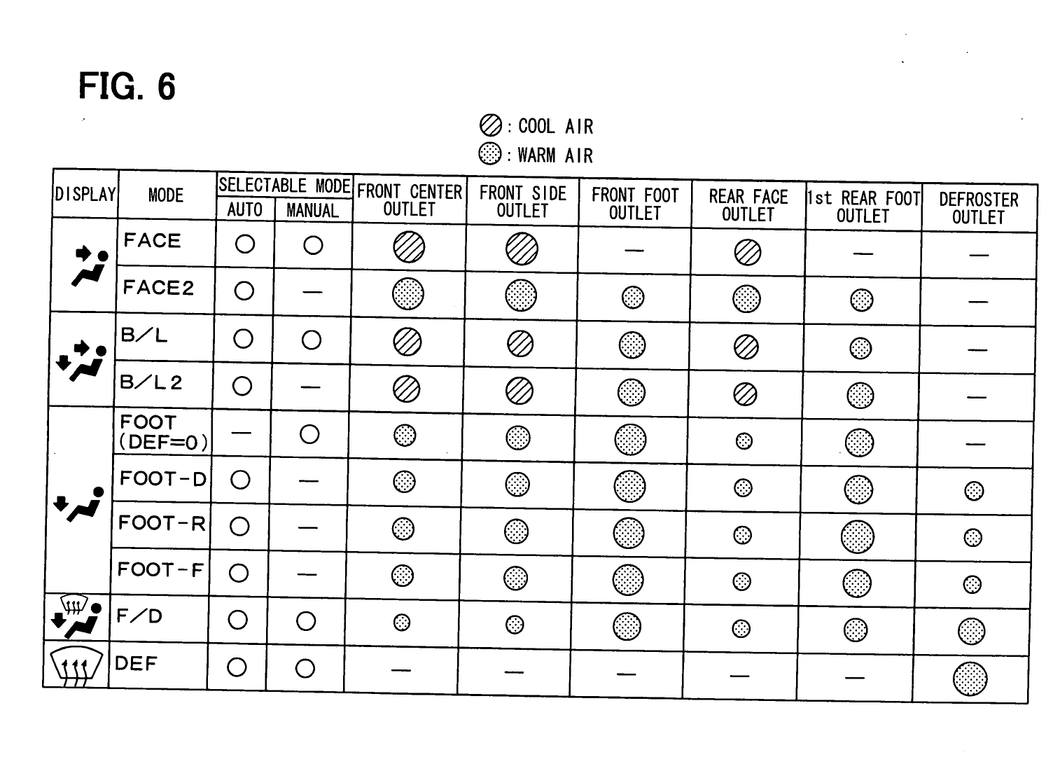

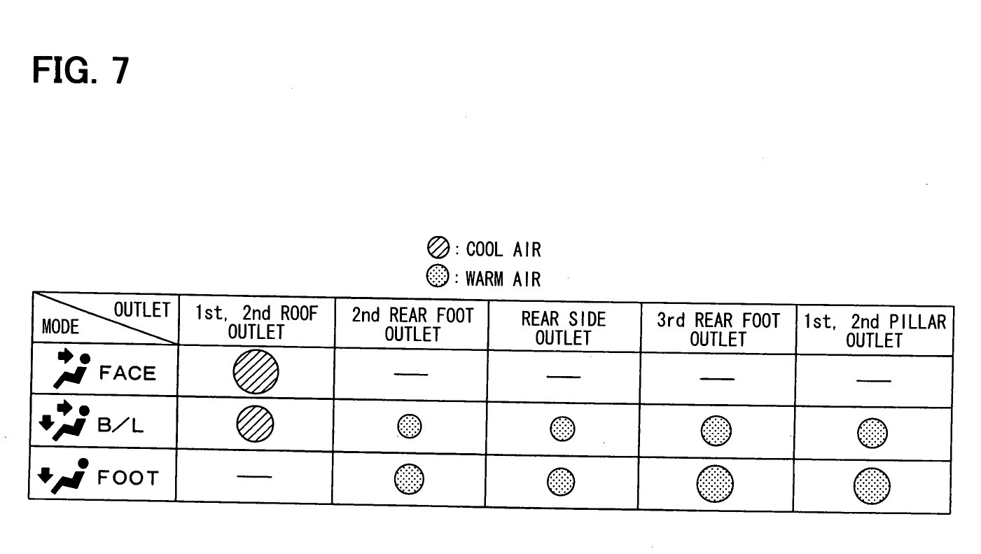

Next, an example of an operation of the air conditioner will be described with reference to FIGS. 6 and 7.

In FIG. 6, “defroster outlet” includes the center defroster outlet 29 and the side defroster outlets 30, 31. In FIGS. 6 and 7, the size of symbols (circles) represents the volume of air (warm air or cool air) blown from the corresponding outlets.

In FIG. 6, “AUTO” of a selectable mode means an automatic operation mode that is selected by turning on an auto switch of an air conditioner control panel (not shown). In the automatic operation mode, an air-blowing mode is selected by the electronic control unit. “MANUAL” of the selectable mode means a manual operation mode which is set when the auto switch is not turned on and in which the air-blowing mode is manually selected by air-blowing mode switches of the air conditioner control panel.

(1) In a FACE mode, which is generally selected for a cooling operation such as in summer, the conditioned air (cool air) is generated in the front air conditioning unit 10 and is blown from the front center outlets 34, 35, the front side outlets 36, 37 and the rear face outlets 52, 53. Also, the conditioned air (cool air) is generated in the rear air conditioning unit 60 and is blown from the first and second roof outlets 73, 74, 75, 76.

A FACE 2 mode is provided only to the front air conditioning unit 10. In the FACE 2 mode, the conditioned air (warm air) generated in the front air conditioning unit 10 is blown from the front center outlets 34, 35, the front side outlets 36, 37, the front foot outlets 40, 41, the rear face outlets 52, 53 and the first rear foot outlets 49, 50.

(2) In a B/L mode (bi-level mode), which is generally used in a middle season such as in spring and autumn, the conditioned air is blown from all the outlets other than the defroster outlets 29, 30, 31.

That is, the conditioned air (cool air) is generated in the front air conditioning unit 10 and is blown from the front center outlets 34, 35, the front side outlets 36, 37, and the rear face outlets 52, 53. Also, the conditioned air (warm air) generated in the front air conditioning unit 10 is blown from the front foot outlets 40, 41 and the first rear foot outlets 49, 50.

The conditioned air (cool air) is generated in the rear air conditioning unit 60 and is blown from the first and second roof outlets 73, 74, 75, 76. Further, the conditioned air (warm air) is generated in the rear air conditioning unit 60 and is blown from the second rear foot outlets 77, 78, the rear side outlets 81, 82, the third rear foot outlets 79, 80 and the first and second pillar outlets 83, 84, 85, 86.

A B/L 2 mode (bi-level 2 mode) is provided only to the front air conditioning unit 10. In the B/L mode 2, the conditioned air (cool air) is generated in the front air conditioning unit 10 and is blown from the front center outlets 34, 35, the front side outlets 36, 37 and the rear face outlets 52, 53. Also, the conditioned air (warm air) is generated in the front air conditioning unit 10 and is blown from the front foot outlets 40, 41 and the first rear foot outlets 49, 50.

(3) In a FOOT mode, which is generally selected for a heating operation such as in winter, the conditioned air (warm air) is blown from all the outlets other than the defroster outlets 29, 30, 31 and the first and second roof outlets 73, 74, 75, 76.

That is, the conditioned air (warm air) generated in the front air conditioning unit 10 is blown from the front center outlets 34, 35, the front side outlets 36, 37, the front foot outlets 40, 41, the rear face outlets 52, 53 and the first rear foot outlets 49, 50. Also, the conditioned air (warm air) generated in the rear air conditioning unit 60 is blown from the second rear foot outlets 77, 78, the rear side outlets 81, 82, the third rear foot outlets 79, 80 and the first and second pillar outlets 83, 84, 85, 86.

FOOT-D mode, FOOT-R mode, and FOOT-T mode are provided only to the front air conditioning unit 10. The conditioned air (warm air) generated in the front air conditioning unit 10 is blown from the front center outlets 34, 35, the front side outlets 36, 37, the front foot outlets 40, 41, the rear face outlets 52, 53, the first rear foot outlets 49, 50 and the defroster outlets 29, 30, 31.

(4) A F/D (foot defroster) mode, which is generally selected for a heating operation such as in winter, is provided only to the front air conditioning unit 10. The conditioned air (warm air) generated in the front air conditioning unit 10 is blown from the front center outlets 34, 35, the front side outlets 36, 37, the front foot outlets 40, 41, the rear face outlets 52, 53, the first rear foot outlets 49, 50 and the defroster outlets 29, 30, 31.

(5) A DEF (defroster) mode is generally selected for an anti-fog operation of window glasses. The DEF mode is provided only to the front air conditioning unit 10. The conditioned air (warm air) generated in the front air conditioning unit 10 is blown only from the defroster outlets 29, 30, 31.

In the present embodiment, the air conditioner has the rear face outlets 52, 53, the second rear foot outlets 77, 78, the first and second pillar outlets 83, 84, 85, 86 and the rear side outlets 81, 82, in addition to the first and second roof outlets 73, 74, 75, 76 and the first and third rear foot outlets 49, 50, 79, 80. Therefore, air conditioning environment as enveloping the passengers seated on the second and third seat rows 2, 3 can be created. The sensation that the conditioned air is locally applied is reduced. Accordingly, the comfort of the passengers seated on the second and third seat rows 2, 3 enhances.

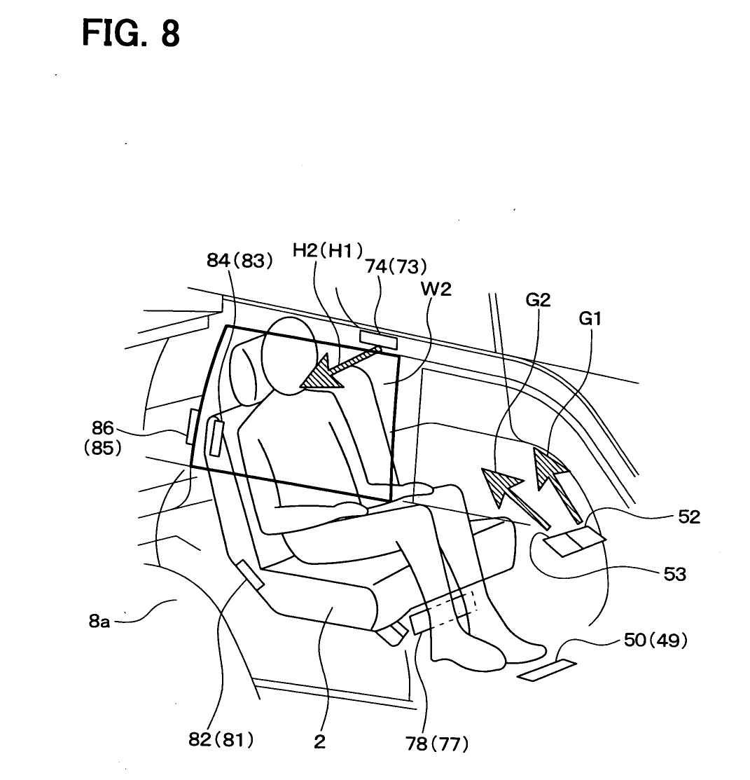

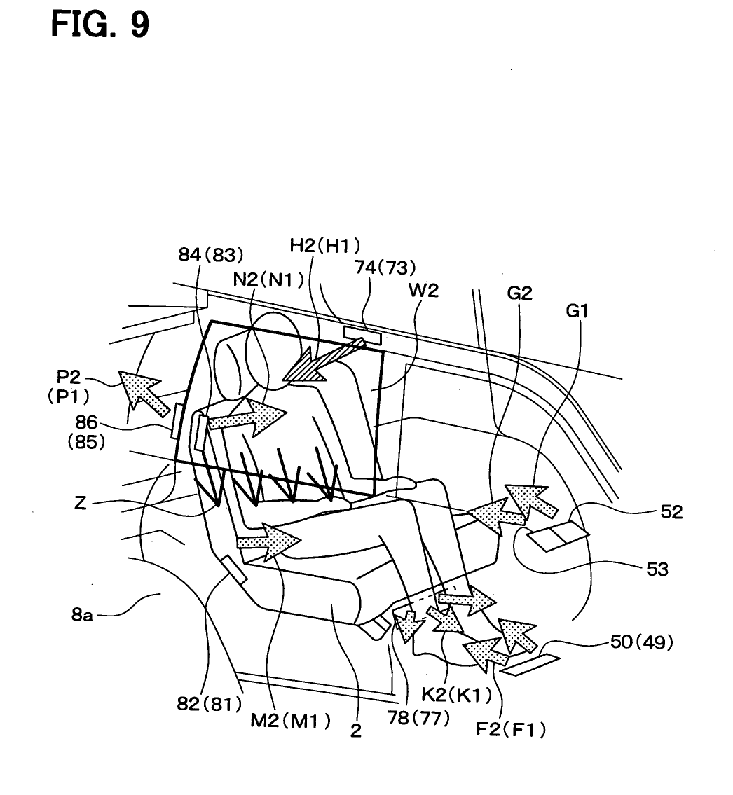

Next, an advantageous effect of the present embodiment will be described with reference to FIGS. 8 and 9. FIG. 8 shows an operation of the FACE mode for a passenger seated on a right seating position of the second seat row 2. Because an operation of the FACE mode for a passenger seated on a left seating position of the second seat row 2 is performed in the similar manner as the operation for the passenger seated on the right seating position, corresponding numerals are shown in parentheses in FIG. 8 and an illustration thereof is omitted.

As shown in FIG. 8, when the FACE mode is selected for the cooling operation such as in summer, the cool air is blown from the first roof outlets 73, 74 toward the head of the passenger seated on the second seat row 2, as shown by the arrow H1, H2. In addition, the cool air is blown from the rear face outlets 52, 53 toward the upper body of the passenger seated on the second seat row 2, as shown by the arrow G1, G2. Therefore, the passenger seated on the second seat row 2 has a sensation as enveloped with the cool air, and thus feels comfortable.

FIG. 9 shows an operation of the B/L mode performed for the passenger seated on the right seating position of the second seat row 2. Because an operation of the B/L mode for the passenger seated on the left seating position of the second seat row 2 is performed in the similar manner as the operation for the passenger seated on the right seating position, corresponding numerals are shown in parentheses in FIG. 9, and an illustration thereof is omitted. Also, an operation of the FOOT mode is performed similar to the B/L mode shown in FIG. 9 except that the cool air is not blown from the first roof outlets 73, 74. Therefore, the operation of the FOOT mode is not shown.

As shown in FIG. 9, when the B/L mode is selected in the middle season such as spring or autumn, or when the FOOT mode is selected for the heating operation such as in winter, the warm air is blown from the first rear foot outlets 49, 50 toward the feet of the passenger seated on the second seat row 2, as shown by the arrow F1, F2. In addition, the warm air is blown from the rear face outlets 52, 43 toward the upper body of the passenger seated on the second seat row 2, as shown by the arrow G1, G2. Moreover, the warm air is blown from the second rear foot outlets 77, 78 toward the calves of the passenger seated on the second seat row 2, as shown by the arrow K1, K2. Therefore, the passenger seated on the second seat row 2 has a sensation as enveloped with the warm air, and thus feels comfortable.

Further, the warm air is blown from the first pillar outlets 83, 84 toward the inner surface of the second seat row window glass W2, as shown by the arrow N1, N2. Also, the warm air is blown from the rear side outlets 81, 82 toward the upper legs of the passenger seated on the second seat row 2, as shown by the arrow M1, M2. Therefore, cold draft (arrow Z) due to cold radiation from the second seat row window glass W2 is reduced.

Similarly, for the passenger seated on the third seat row 3, the warm air is blown from the third rear foot outlets 79, 80 toward the feet, as shown by the arrow P1, P2. In addition, the warm air is blown from the second pillar outlets 85, 86 toward the inner surface of the third seat row window glass W3. Therefore, cold draft due to cold radiation from the third seat row window glass W3 is reduced.

Accordingly, the air conditioning sensation of the passengers seated on the second and third seat rows 2, 3 enhances.

The front air conditioning unit 10 and the rear air conditioning unit 60 can be constructed as a right and left temperature independent control type that is capable of independently controlling the temperatures of airs blown toward a right region and a left region of the passenger compartment. In this case, the conditioned air is blown toward each passenger at his desired temperature and in an enveloping manner. That is, comfortable environment is created for each passenger. Therefore, the air conditioning sensation of each passenger enhances.

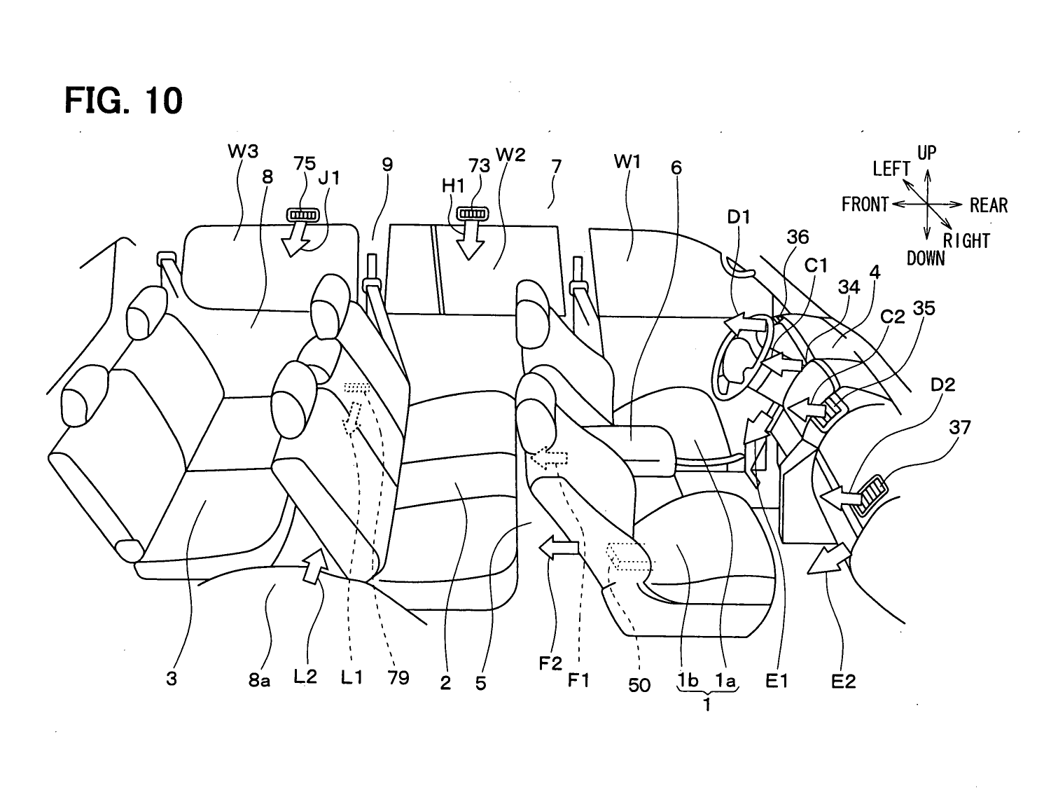

In the present embodiment, the air conditioner has the rear face outlets 52, 53, the second rear foot outlets 77, 78, the rear side outlets 81, 82, the first pillar outlets 83, 84 and the second pillar outlets 85, 86. Therefore, the number of outlets increases, as compared with the air conditioner shown in FIG. 10. As a result, the volume of air blown from each outlet is reduced. Accordingly, noise of air blown from the outlet is reduced.

### Other Embodiments

In the above embodiment, an exemplary arrangement of the outlets is described, but the arrangement of the outlets may be suitably modified as long as the similar effects are achieved.

In the above embodiment, an example of air-blowing modes is described. However, the air conditioner may have any other air-blowing modes.

In the above embodiment, each of the doors 18, 19, 32, 33 and the like is driven by the servomotor. However, the doors may be driven by any other mechanism. For example, the doors may be driven by manual driving mechanisms that are manually operated by a user.

In the above embodiment, the air conditioner is exemplarily employed to the left-hand drive vehicle. Alternatively, the air conditioner can be employed to a right-hand drive vehicle.

Additional advantages and modifications will readily occur to those skilled in the art. The invention in its broader term is therefore not limited to the specific details, representative apparatus, and illustrative examples shown and described.

What is claimed is:

1. An air conditioner for a vehicle having at least a first seat row, a second seat row and a third seat row in a passenger compartment, the first seat row, the second seat row and the third seat row being arranged behind each other along a longitudinal axis of the vehicle, the air conditioner comprising:
an air conditioning unit capable of generating a conditioned air;
a first roof outlet disposed on a ceiling of the passenger compartment and capable of blowing the conditioned air toward a head area of a passenger seated on the second seat row;
a second roof outlet disposed on the ceiling and capable of blowing the conditioned air toward a head area of a passenger seated on the third seat row;
a rear face outlet disposed adjacent to a backrest of the first seat row and capable of blowing the conditioned air toward an upper body area of the passenger seated on the second seat row;
a first rear foot outlet disposed adjacent to a lower portion of the second seat row and capable of blowing the conditioned air toward a foot area of the passenger seated on the second seat row;
a second rear foot outlet disposed adjacent to a lower portion of the second seat row and capable of blowing the conditioned air toward a lower leg area of the passenger seated on the second seat row;
a third rear foot outlet disposed adjacent to a lower portion of the third seat row and capable of blowing the conditioned air toward a foot area of the passenger seated on the third seat row;
a first pillar outlet disposed on a pillar of the vehicle and capable of blowing the conditioned air toward a second side window glass of the vehicle that is located on a side of the second seat row;
a second pillar outlet disposed on the pillar of the vehicle and capable of blowing the conditioned air toward a third side window glass of the vehicle that is located on a side of the third seat row; and
a rear side outlet disposed on a side wall of the passenger compartment and capable of blowing the conditioned air toward an upper leg area of the passenger seated on the second seat row.

2. The air conditioner according to claim 1, wherein
the air conditioning unit is capable of performing a cooling operation, and
in the cooling operation, the conditioned air is blown from the first roof outlet, the second roof outlet and the rear face outlet.

3. The air conditioner according to claim 1, wherein
the air conditioning unit is capable of performing a heating operation, and
in the heating operation, the conditioned air is blown from the rear face outlet, the first rear foot outlet, the second rear foot outlet, the third rear foot outlet, the first pillar outlet, the second pillar outlet and the rear side outlet.

4. The air conditioner according to claim 1, wherein
the air conditioning unit includes a front unit to be disposed at a front part of the passenger compartment and a rear unit to be disposed at a rear part of the passenger compartment,
the front unit is in communication with the rear face outlet and the first rear foot outlet, and
the rear unit is in communication with the first roof outlet, the second roof outlet, the second rear foot outlet, the third rear foot outlet, the first pillar outlet, the second pillar outlet and the rear side outlet.

5. The air conditioner according to claim 1, wherein
the rear face outlet is located on a rear face of a console disposed in the first seat row,
the second rear foot outlet is located on a floor of the passenger compartment under the second seat row,
the first pillar outlet is located on a front face of the pillar, and
the second pillar outlet is located on a rear face of the pillar.
